(19) United States
(12) Patent Application Publication
(10) Pub. No.: US 2002/0031324 A1
(43) Pub. Date: Mar. 14, 2002

(54) Variable optical attenuator using microelectro mechanical mirror

(76) Inventors: Simon Xiaofan Cao, Fremont, CA (US); John Arthur Fee, Garland, TX (US)

Correspondence Address: SAWYER LAW GROUP LLP, P.O. Box 51418, Palo Alto, CA, 94303, US

(21) Appl. No.: 09/796,267

(22) Filed: Feb. 27, 2001

Related U.S. Application Data
(63) Continuation-in-part of application No. 09/660,451, filed on Sep. 12, 2000.

(51) Int. Cl. G02B 6/26

(52) U.S. Cl. 385/140; 385/25

(57) ABSTRACT

The present invention provides a method and system for attenuating power in an optical signal. The method includes providing the optical signal to a reflective surface; tilting the reflective surface at a desired angle; and reflecting the optical signal into an optical fiber, wherein the reflected optical signal enters the optical fiber with a misalignment based upon the angle. The method and system utilizes a variable optical attenuator comprising a micro-machined movable support with a mirror coating. An optical signal is transferred onto the mirror coating, which is then reflected back. The movable support may be tilted at a desired angle such that the optical signal is reflected back into an output optical fiber with a controlled variable misalignment. The variable optical attenuator of the present invention is capable of precise and reproducible operation. It is capable of attenuating the optical signal in real time and in attenuating all of the channels in an optical signal simultaneously. Because of its small size, it is extremely rigid and vibration insensitive. Because it has no bulk mechanical parts, it does not wear out.

### CROSS-REFERENCE TO RELATED APPLICATIONS

This application is a Continuation-In-Part of co-pending U.S. patent application Ser. No. 09/660,451, entitled “Variable Optical Attenuator Using Microelectro Mechanical Mirror,” filed Sep. 12, 2000.

### FIELD OF THE INVENTION

The present invention relates to fiber optic networks, and more particularly to signal attenuation in fiber optic networks.

### BACKGROUND OF THE INVENTION

Fiber optic networks are becoming increasingly popular for data transmission due to their high speed, high capacity capabilities. FIG. 1 illustrates a portion of a conventional wavelength division multiplexed (WDM) fiber optic network. The network 100 comprises a bank of light sources 102 which provides the light upon which the signals are modulated. The signals then travel along optical fibers 104 toward a destination node 110. Occasionally, the signals must be amplified by an optical amplifier 106, such as an Erbium Doped Fiber Amplifier (EDFA) due to attenuation of the signal strength. Typically, an optical signal must be amplified after it travels approximately 80 km.

The power level of digital or analog data transmissions over any given segment of the WDM network 100 will generally vary over time. With increasing network complexity, rapid or short-term power fluctuations in signal levels are becoming of increasing concern. Such fluctuations may be caused by fluctuations in the number of data channels carried by the network 100 and variability of the routing of the various signal channels prior to their arrival at that segment. Furthermore, both the total gain and the average gain per channel provided by the optical amplifier 106 may depend upon the number of channels carried by the network 100 at the point of the amplifier 106. This latter quantity can vary virtually instantaneously in the network 100 depending upon network traffic conditions and routing configurations.

For the above reasons, the total power level can fluctuate rapidly within a segment of a complex WDM network 100. Notwithstanding such power fluctuations, it is usually desirable for the average transmitted power of each channel to remain substantially constant. For instance, if signal power levels at optical receivers are too low, then problems of low signal-to-noise will result. Conversely, if power levels at receivers are too high, the detectors therein may saturate, thereby making them insensitive to small changes in the signal.

Conventional fixed attenuation devices are impractical for use within a complex WDM system, in which signal power levels and total power may vary within the time frame of milliseconds. Conventional variable optical attenuators are subject to one or more shortcomings, including undesirable back-reflections to the light source, complexity and bulk to the device, and long-term instability caused by the localized mechanical stresses placed upon the fibers.

Also, in conventional variable optical attenuators which utilize some form of macroscopic mechanical device to control the attenuator, the response time is limited to the speed of the bulk moving parts and is not suitable for repetitive, long-term dynamic attenuation control in the range of milliseconds. Furthermore, in such devices with bulk moving parts, the attenuator may be subject to wear and to interferences from vibrations, shocks, actuator friction, and thermal stresses. In the case of conventional non-mechanical variable attenuators, they typically comprise a number of separate optical parts whose alignment is difficult and must be precisely controlled.

Furthermore, WDM systems may potentially be bi-directional in operation. In other words, along a single optical fiber, a first set of signals may propagate in a first direction whilst a second set of signals independently propagates in a second direction opposite to the first direction. The signal attenuation requirements may be different between the first and second sets of signals. Such discrepant attenuation requirements are not addressed by any of the conventional attenuators.

Accordingly, there is a need for an improved method and system for variable gain attenuation. The method and system should address the issues described above. The present invention addresses such a need.

### SUMMARY OF THE INVENTION

The present invention provides a method and system for attenuating power in an optical signal. The method includes providing the optical signal to a reflective surface; tilting the reflective surface at a desired angle; and reflecting the optical signal into an optical fiber, wherein the reflected optical signal enters the optical fiber with a misalignment based upon the angle. The method and system utilizes a variable optical attenuator comprising a micro-machined movable support with a mirror coating. An optical signal is transferred onto the mirror coating, which is then reflected back. The movable support may be tilted at a desired angle such that the optical signal is reflected back into an output optical fiber with a controlled variable misalignment. The variable optical attenuator of the present invention is capable of precise and reproducible operation. It is capable of attenuating the optical signal in real time and in attenuating all of the channels in an optical signal simultaneously. Because of its small size, it is extremely rigid and vibration insensitive. Because it has no bulk mechanical parts, it does not wear out.

### BRIEF DESCRIPTION OF THE FIGURES

FIG. 1 illustrates a portion of a conventional fiber optic network.

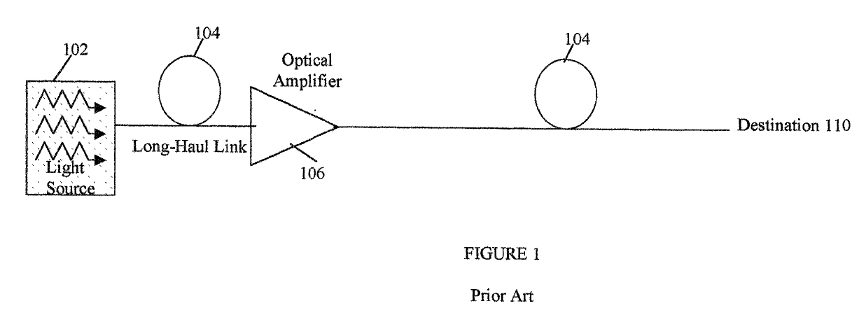

FIG. 2 illustrates an optical network which performs variable optical attenuation in accordance with the present invention.

FIG. 3a illustrates a first preferred embodiment of a variable optical attenuator in accordance with the present invention.

FIG. 3b illustrates a second preferred embodiment of a variable optical attenuator in accordance with the present invention.

FIG. 4 illustrates the functioning of the variable optical attenuator in accordance with the present invention.

FIG. 5a illustrates a third preferred embodiment of a variable optical attenuator in accordance with the present invention.

FIG. 5b illustrates a fourth preferred embodiment of a variable optical attenuator in accordance with the present invention.

FIG. 6 illustrates a system for utilizing the third preferred embodiment of the variable optical attenuator in a bi-directional optical network in accordance with the present invention.

FIG. 7 illustrates another system for utilizing the second preferred embodiment of the variable optical attenuator in a bi-directional optical network in accordance with the present invention.

FIG. 8 is a flow chart illustrating a preferred embodiment of a method of variable attenuation utilizing the variable optical attenuator in accordance with the present invention.

FIG. 9A illustrates a first preferred embodiment of a network which utilizes a VOA in accordance with the present invention.

FIG. 9B illustrates a second preferred embodiment of a network which utilizes a VOA in accordance with the present invention.

FIG. 9C illustrates a third preferred embodiment of a network which utilizes a VOA in accordance with the present invention.

FIG. 10 illustrates a fourth preferred embodiment of a network which utilizes a VOA in accordance with the present invention.

FIG. 11 illustrates a fifth preferred embodiment of a network which utilizes a VOA in accordance with the present invention.

FIG. 12 illustrates amplifier gain flattening accomplished via the network of FIG.11.

FIG. 13 illustrates a sixth preferred embodiment of a network which utilizes a VOA in accordance with the present invention.

### DETAILED DESCRIPTION

The present invention provides for an improved method and system for variable power attenuation in an optical network. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

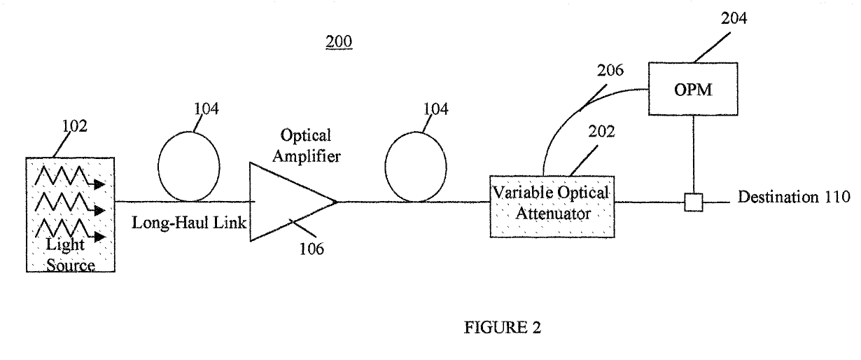

To more particularly describe the features of the present invention, please refer to FIGS. 2 through 13 in conjunction with the discussion below.

FIG. 2 illustrates an optical network which performs variable optical attenuation in accordance with the present invention. The optical network 200 comprises a variable optical attenuator 202 (VOA). The VOA 202 may be manually adjusted to attenuate the gain of all of the channels of the optical signal to a desired level. In the alternative, the VOA 202 may be adjusted automatically using an optical performance monitor 204. The optical performance monitor 204 measures spectral characteristics of the transmitted signals and determines the amount of attenuation required, and then adjusts the VOA 202 accordingly, via a communications link 206. The optical performance monitor 204 is disclosed in a co-pending U.S. Patent Application entitled, “Optical Performance Monitor”, Ser. No. 09/401,735, filed on Sep. 22, 1999. Applicant hereby incorporates this Patent Application by reference.

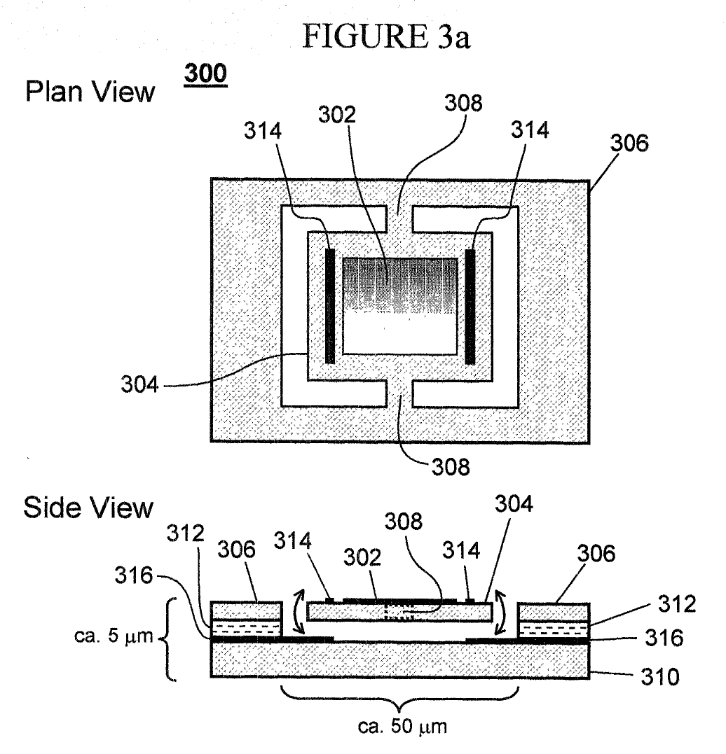

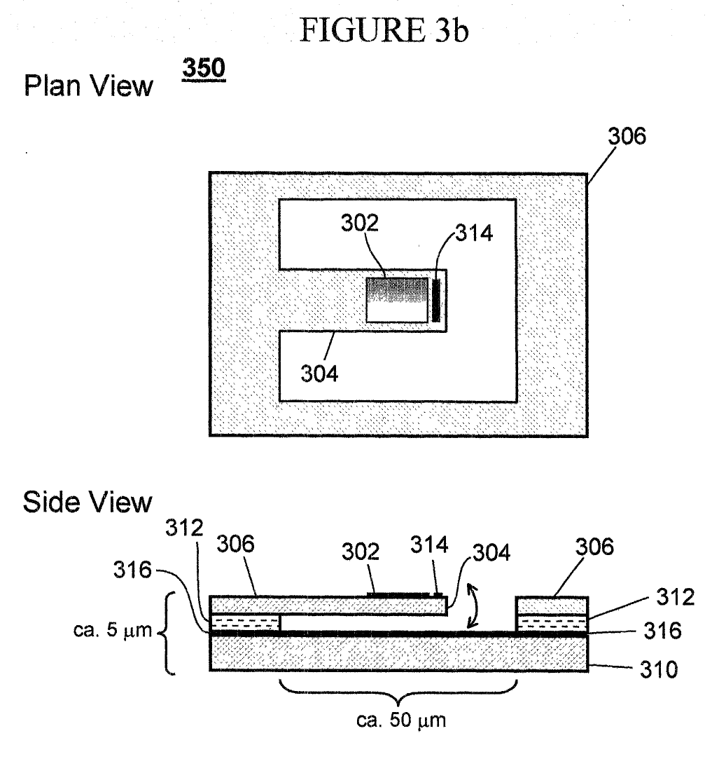

FIG. 3a illustrates a first preferred embodiment of a VOA in accordance with the present invention in both a plan view and a side view. The VOA 300 comprises a mirror coating 302 on a movable support 304. The movable support 304 is connected to a fixed support 306 such that the movable support 304 is free to tilt. In the first preferred embodiment, the connection comprises two handles 308 about which the support 304 may rotate. The handles 308 are more properly described as torsion beams because twisting about the handles (torsion beams) 308 causes the tilting of the movable support 304 and provides a restoring force against an electrostatically induced tilt of the moveable support. Underneath the fixed support 306 is a lower substrate layer 310 composed of a material such as silicon, and an upper electrically insulating layer 312 composed another material such as silicon dioxide or silicon nitride. The upper layer 312 does not extend underneath the movable support 304 so that the movable support 304 may be free to tilt. Two upper electrodes 314 are attached to the movable support 304. Lower electrodes 316, preferably two in number, are located between the lower layer 310 and the upper layer 312. A portion of each lower electrode 316 extends underneath the movable support 304. The upper and lower electrodes 314 and 316 are supplied voltages which create electrostatic forces. Based on the voltages supplied, the movable support 304 will tilt in a certain direction and at a certain angle. For example, voltage differences on the order of 50-70 volts are required for maximum tilt. The voltages are kept sufficiently low so that the device 300 always operates in the analog mode with an approximately linear relationship between deflection and applied voltage. In the first preferred embodiment, the mirror coating 302 is composed of gold. Also, the thickness of the device 300 is approximately 5 μm, and the length of the movable support is approximately 50 μm. Because of its small size, the VOA 300 is extremely rigid and vibration insensitive. Because it has no bulk mechanical parts, the VOA 300 does not wear out.

Although the VOA 300 is described as comprising the above materials, one of ordinary skill in the art will understand that other materials may be used without departing from the spirit and scope of the present invention. For example, a material other than gold may be used for the mirror coating 302. Other materials may also be used for the upper and lower layers 310, 312 of the fixed support 306. Although the VOA is described with the use of electrodes to tilt the movable support, one of ordinary skill in the art will understand that other means of facilitating the tilt may be used without departing from the spirit and scope of the present invention. For instance, the entire device 300 may be exposed to an external permanent magnetic field and a current caused to flow within loop-shaped electrodes on the movable support such that the tilt is affected by the electromagnetic forces created between the lines of magnetic flux from the permanent magnet and the electric currents. Although the VOA is described as having the above dimensions, one of ordinary skill in the art will understand that the VOA may be fabricated with different dimensions without departing from the spirit and scope of the present invention.

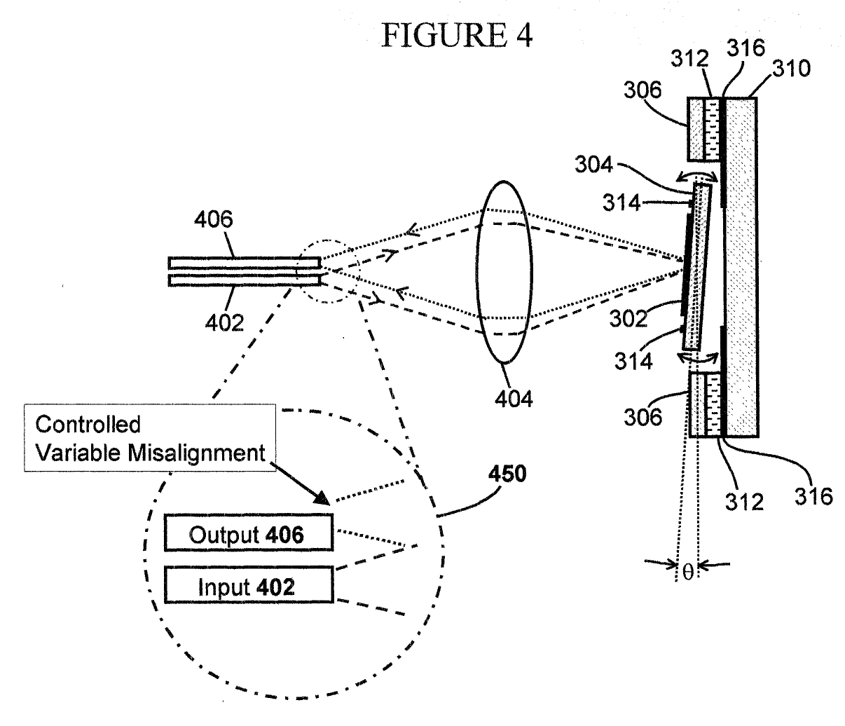

FIG. 3b illustrates a second preferred embodiment of a variable optical attenuator in accordance with the present invention. In the VOA 350 (FIG. 3b), the moveable support 304 comprises a cantilever beam that is attached to the fixed support 306 at only one of its ends and that is free at its other end. Accordingly, the VOA 350 does not comprise “handles” about which torsion occurs, as does the VOA 300 (FIG. 3a). In response to a controlled voltage difference between the upper electrode 314 and the lower electrode 316, the entire moveable support 304 bends upward or downward as indicated by the curved double-headed arrow in the lower portion of FIG. 3b. The moveable support 304 may be constructed such that the flexure associated this bending is concentrated near the attached end of the moveable support whilst the portion supporting the mirror coating 302 remains rigid. The bending movement of the moveable support causes movement of the mirror coating 302 relative to an input signal light as described further below in reference to FIG. 4.

FIG. 4 illustrates the functioning of the VOA 300 (FIG. 3a) in accordance with the present invention. The operation of the VOA 350 (FIG. 3b) is similar. An input optical fiber 402 inputs the optical signal from the network. Based upon information from an analysis of the signals, such as with an optical performance monitor 204 (FIG. 2), it is determined that the movable support 304 should be rotated at an angle θ in order to attenuate the signal to a desired level. The optical signal from the input fiber 402 is focused onto the mirror coating 302 on the movable support 304, by an image transfer lens 404. The image transfer lens 404 is located such that the distance between it and the input optical fiber 402 equals twice the focal length of the lens 404. The distance between the lens 404 and the mirror coating 302 is also equal to twice the focal length of the lens 404. The optical signal transferred onto the mirror coating 302 is immediately sent in the opposite direction back through the image transfer lens 404 but because of rotation of the mirror coating 302, the returning signal is mismatched or misaligned. The mismatched/misaligned signal travels into an output optical fiber 406, as illustrated in more detail in the dotted circle 450. The amount of misalignment is controlled by the tilt of the mirror coating 302. The tilt of the mirror coating 302 is controlled by the voltages applied to the electrodes 314, 316. The misalignment causes attenuation of the signal. This attenuation occurs for all the wavelengths propagating in the fiber.

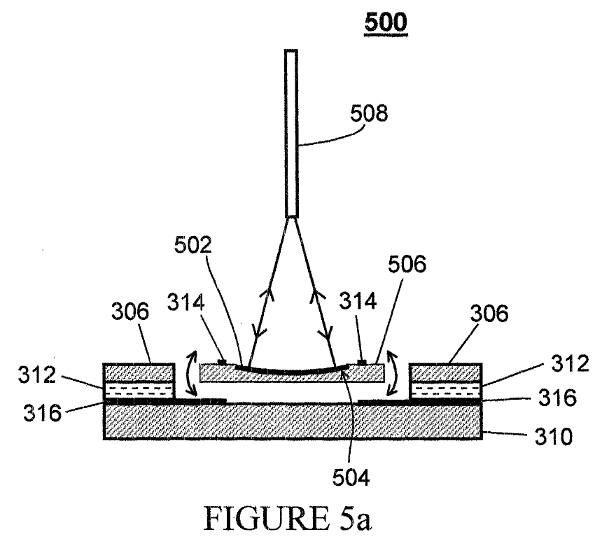

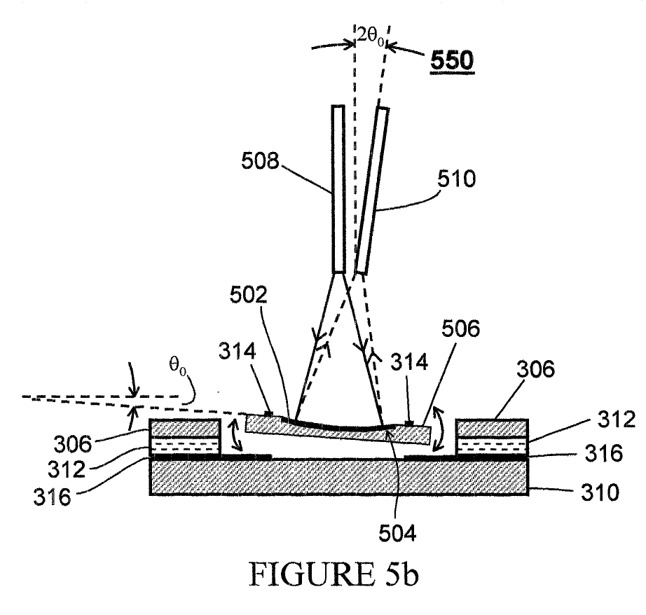

FIG. 5a illustrates a third preferred embodiment of a variable optical attenuator in accordance with the present invention. This third embodiment comprises a single-fiber VOA 500. In the single-fiber VOA 500 (FIG. 5a), the reflective coating 502 is disposed on a curved surface 504 of the upper moveable support 506 of the device. The curved surface 504 is formed as a segment of a spherical surface whose solid angle corresponds to that produced by the diverging fiber output light as shown in FIG. 5. When a single fiber 508 is mounted directly above the reflective spherical surface 504 with the reflective coating 502, and the moveable support 506 is perpendicularly disposed to the fiber axis, the reflective coating 502 reflects output light from the fiber 508 directly back into the same fiber 508 in the opposite direction and without attenuation. Thus, the returned light input to the fiber 508 propagates in the reverse direction from that of the light originally output from the fiber 508. Various degrees of attenuation of the returning light are produced by slightly tilting the support 506 and the curved surface 504 relative to the fiber axis such that only a portion of the light re-enters the fiber 508. In the VOA 500 (FIG. 5a), only a single fiber is used and a separate lens is not employed since the reflective coating 502 upon the curved surface 504 fulfills the function of focusing the return light back into the fiber 508. Because of these modifications, the VOA 500 is more compact and simpler in design than the first and second, two-fiber preferred embodiments 300 (FIG. 3a) and 350 (FIG. 3b).

FIG. 5b illustrates a fourth preferred embodiment of a VOA in accordance with the present invention. The VOA 550 shown in FIG. 5b comprises two fibers—an input fiber 508 and an output fiber 510-as in the first and second preferred embodiments shown in FIGS. 3a-3b, and comprises a curved reflective coating 502 on a curved surface 504—as in the VOA 500 (FIG. 5a). The curved reflective coating 502 receives a diverging light from the input fiber 508 and reflects a converging light back to the output fiber 510. The output fiber 510 may be disposed parallel to the input fiber 508 or may be disposed at an angle 2θ₀ (θ₀>0) relative to the input fiber at its end face. The curved surface 504 upon which the reflective coating 502 is supported may comprise a spherical shape as in the VOA 500 (Fig. 5a) or else may comprise an off-axis parabolic surface to improve the focus of the reflected light in the vicinity of the output fiber 510. This image transfer property of off-axis parabolic reflectors is well known. Further, the moveable support 506 comprising the VOA 550 may comprise a rotating plate supported by “handles”, similar to that shown in FIG. 3a, or may comprise a bending cantilever beam, similar to that shown in FIG. 3b.

If the output fiber 510 is parallel to the input fiber 508, then the maximum transmission (that is, the transmission at the minimum possible attenuation) through the VOA 550 will be reduced relative to that through the VOA 500 because a portion of the converging light will be outside the acceptance angle of the output fiber 510. However, if the end face of the output fiber 510 is disposed at the angle 2θ₀ relative to the input fiber 508, then, when the moveable support 506 is disposed at an angle θ₀ relative to a plane perpendicular to the long dimension of the input fiber 508, a substantial portion of the converging light will be within the acceptance angle of the fiber 510. The maximum light transmission through the VOA 550 occurs when the input fiber and the moveable support are disposed with this angular relationship.

This above-mentioned angular relationship between the movable support and the plane perpendicular to the long dimension of the input fiber 508 at maximum transmission may be produced in a variety of ways. In FIG. 5b, the moveable support 506 is shown tilted relative to the fixed support 306 by an angle θ₀. Since, in the example shown in Fig. 5b, the input fiber 508 is perpendicular to the fixed support 306, the appropriate angular relationship for maximum transmission is accomplished. Alternatively, the moveable support 506 may remain parallel to the fixed support and the input fiber may be disposed at an angle of−θ₀ relative to the plane of the fixed support 506. Alternatively, the appropriate angular relationship may be provided by aligning the input fiber at a non-perpendicular angle relative to the fixed support whilst, simultaneously, tilting the moveable support.

To produce variable optical attenuation of the returning light within the VOA 550, the curved reflective coating 502 is tilted slightly, in either direction, relative to the illustrated maximum transmission position by tilting of the moveable support 506. Since the curved reflective coating 502 fulfills the function of focusing the reflected light into the output fiber 510, a lens is not required in the VOA 550.

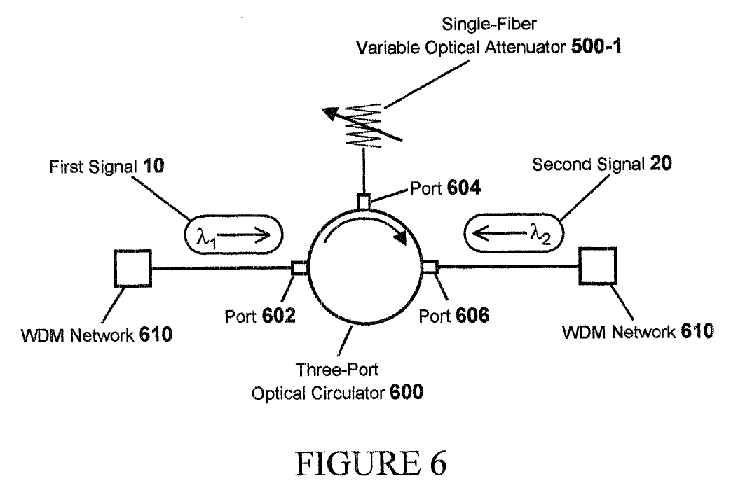

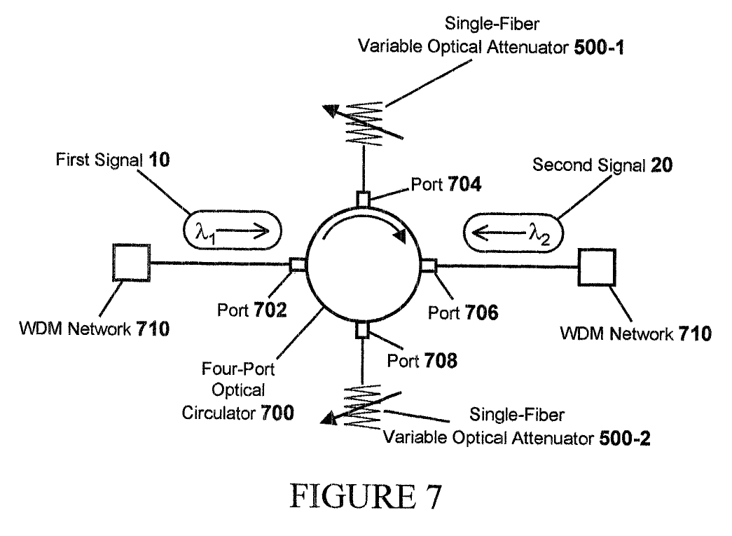

In the single-fiber VOA 500 shown in FIG. 5a, the returning light should be prevented from re-entering the light source or a transmitter must be provided elsewhere in the network because the same fiber is used for both input and output. Either an optical isolator or optical circulator may be used to prevent the returning of the attenuated signals from propagating backwards within the optical network. For example, FIGS. 6 and 7 illustrate two systems by which an optical circulator is used to prevent such re-entry. In both FIGS. 6 and 7, a simple bi-directional WDM network, 610 and 710 respectively, is illustrated in which a first signal 10 comprising a wavelength λ₁ propagates in a first direction (shown as left to right in the figures) and a second signal 20 comprising a wavelength λ₂ propagates in a second direction opposite to the first direction. It is possible that either λ₁ equals λ₂ or λ₁ does not equal λ₂. In the system illustrated in FIG. 6, a single-fiber VOA 500-1 is optically coupled to the intermediate port, Port 604, of a three-port optical circulator 600 and the bi-directional WDM network 610 is optically coupled to the circulator 600 through its end ports, Port 602 and Port 606, respectively. Light of the first signal 10, comprising the wavelength λ₁ enters the circulator 600 through Port 602 from which it is directed to Port 604 and thence to the single-fiber VOA 500-1. The attenuator 500-1 provides a certain controlled degree of attenuation to the first signal 10 of wavelength λ₁ and thence reflects the attenuated first signal back to the circulator Port 604. From Port 604, the attenuated first signal is directed to Port 606, from which it exits the circulator 600 and returns to the WDM network 610. Because the circulator 600 only circulates light in one direction, the returning first signal is prevented from returning to the WDM network 610 from Port 602 and thus is prevented from causing damage to light sources or other active components. The second signal 20, comprising the wavelength λ₂ enters the circulator 600 through its Port 606 from which it is directed to Port 602 where it returns to the WDM network 610 without attenuation. Thus, the system illustrated in FIG. 6 comprises a method for attenuating only a subset of signals propagating in a first direction within a bi-directional WDM network 610.

The system illustrated in FIG. 7 is similar to that illustrated in FIG. 6 except that a four-port optical circulator 700 is utilized and a second single-fiber VOA 500-2 is optically coupled to the additional port, Port 708. Light of the first signal 10, comprising the wavelength λ₁ follows a similar pathway to illustrated in FIG. 6. In other words, the first signal 10 is input at port 702, is then output from port 704 to the variable optical attenuator 500-1, is then returned to port 704 and directed to port 706 and is then output to the WDM network 710. However, in the system of FIG. 7, the second signal light 20 comprising the wavelength λ₂ is not immediately directed from Port 706 to Port 702 but instead exits the circulator 700 from Port 708 from which it is directed to the second single-fiber VOA 500-2. This second attenuator 500-2 provides a certain controlled degree of attenuation to the second signal 20 of wavelength λ₂ and thence reflects the attenuated second signal back to the circulator Port 708. The attenuation provided to the second signal 20 can be independent of that provided to the first signal 10 by the first attenuator 500-1. From Port 708, the attenuated second signal is directed to Port 702, from which it exits the circulator 700 and returns to the WDM network 710 in a direction opposite to that from the first signal 10. Thus, the system illustrated in FIG. 7 comprises a method for independently attenuating each of the mutually counter-propagating subsets of signals in a bi-directional WDM network 710.

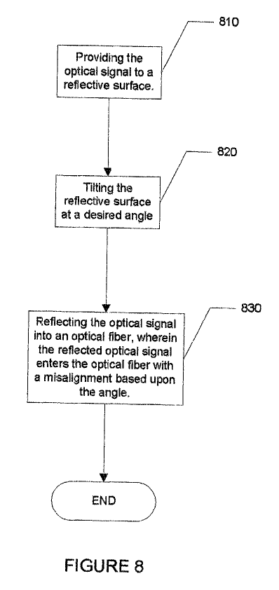

FIG. 8 is a flow chart illustrating a preferred embodiment of a method of variable attenuation utilizing a VOA in accordance with the present invention. First, an optical signal is provided to a reflective surface, via step 810. Within the first through fourth preferred embodiments of a VOA 300, 350, 500, and 550, the optical signal is transferred onto a mirror coating 302 or 502. Next, the reflective surface is tilted at a desired angle, via step 820. Within the VOA's in accordance with the present invention, the tilt angle is caused by voltages applied to the electrodes 314, 316. Then, the optical signal is reflected into an optical fiber, where the reflected optical signal enters the optical fiber with a misalignment based upon the angle, via step 830. Within the VOA's in accordance with the present invention, the optical signal is reflected from the mirror coating 302 or 502 back into the optical fiber 406, 508, or 510. The reflected signal enters the optical fiber 406, 508, or 510 with a misalignment, which in turn attenuates the signal, as described above.

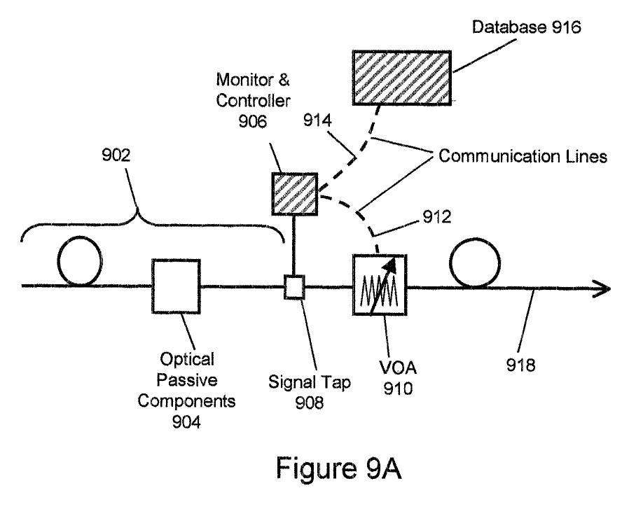

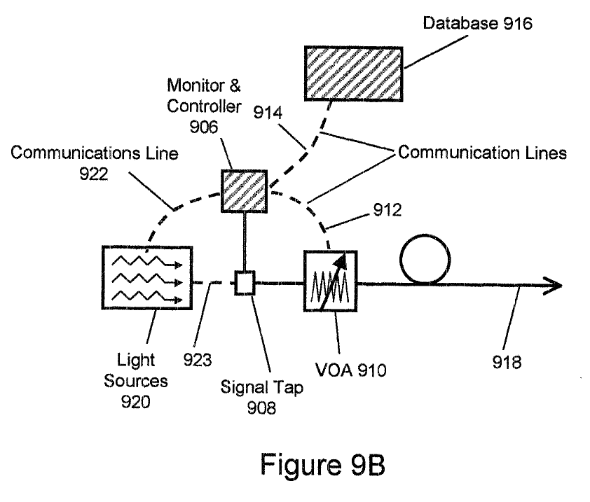

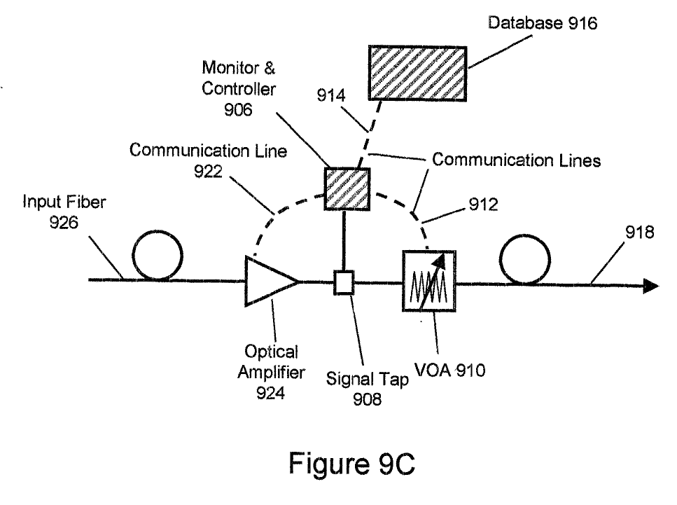

Several ways of utilizing of the variable optical attenuator (VOA) within an optical communications network are now described with reference to FIGS. 9A through 13. FIGS. 9A-9C illustrate three preferred embodiments of networks which utilizes a VOA together with a monitor/controller and an automated database in accordance with the present invention. FIG. 9A illustrates a first preferred embodiment of a network which utilizes a VOA in accordance with the present invention. The network in FIG. 9A uses a VOA in conjunction with monitoring the throughput of optical passive components. FIGS. 9B and 9C illustrate networks which use a VOA in conjunction with monitoring and control of lasers and optical amplifiers, respectively. In FIGS. 9A-9C, solid lines, where referring to communications or transmission means, represent optical fibers or fiber systems, and dashed lines refer to general communications or transmission lines or links. However, such transmission or communications links may, in general, comprise any means for carrying communications, beams or signals such as electrical wires, optical fibers, radio waves, solid-state wave guides or free-space light beams.

In FIG. 9A, the set of optical passive components 904 represents any number of signal attenuating components throughout a span or segment 902 of an optical fiber communications system. Because of the general properties of optical components, each such component within component set 904 is associated with a non-zero insertion loss. The cumulative insertion loss may gradually increase over long periods of time due to slow degradation of components. In rare circumstances, the cumulative insertion loss may increase or decrease on a rapid time scale (minutes-hours) as a result of changing environmental factors. These variations in insertion loss are associated with undesirable optical power fluctuations or changes within the signals carried by the optical communications system. In the network shown in FIG. 9A, the monitor/controller 906 measures these signal power variations and sends control signals to the VOA 910 so as to correct for them.

In the network shown in FIG. 9A, the signal tap 908 and VOA 910 are disposed at the end of the fiber system segment 902 so as to receive the signal(s) subsequent to their passage through the optical component set 904. The signal tap 908 diverts a small proportion or sample of the signals carried through the optical communications system to the output monitor/controller 906. With respect to the signal propagation direction within the fiber system segment 902, the VOA 910 is disposed within the network immediately after the signal tap 908 and is coupled to the monitor/controller 906 via a communications line 912. The output/monitor controller 906 is also coupled to a database 916 via a second communications line 914. Preferably, the two communications lines 912-914 are electronic communications lines.

At the very least, the output/monitor controller 906 measures the optical power levels of one or more channels of the sample signal diverted to it by the signal tap 908, converts these measurements of the samples signals to calculated optical power levels within the communications span 902, records these data and/or calculations in the data base 916 and sends control signals to the VOA 910 based upon the received data. The VOA 910 attenuates the plurality of signals to a greater or lesser extent depending upon the optical power levels within the network determined by the monitor/controller 906. In this way, the operation of the VOA 910 tends to stabilize the optical power within the downstream or subsequent span 918 of the network. The information stored in the database 916 comprises a permanent continuous record of the optical power levels measured by monitor/controller 906 and/or the control signals transmitted to the VOA 910. This information is in a form than can be used to develop a continuous record of the throughput of the network. Preferably, the database 916 is some form of computerized or other electronic record-keeping system.

FIG. 9B illustrates a second preferred embodiment of a network which utilizes a VOA in accordance with the present invention. The network in FIG. 9B is similar to that shown in FIG. 9A except that the power outputs of a plurality of transmitter light sources 920 are monitored and controlled by the monitor/controller 906 and VOA 910. Variations in the performance of the light sources 920 can lead to undesirable optical power level fluctuations and/or changes within the network. Within certain limits, the variations in light source output can be controlled. However, controlled operation of the light sources outside such power limits can lead to instability or decreased lifetimes of the light sources. Therefore, in the network illustrated in FIG. 9B, a VOA 910 is used in addition to the inherent light source control mechanisms.

In the network shown in FIG. 9B, the monitor/controller 906 measures any signal power variations and sends control signals to the VOA 910 and/or the light sources 920 so as to correct for them. The functions and dispositions of the signal tap 908, VOA 910, communications lines 912-914, database 916 and downstream fiber span 918 are similar to their respective functions and dispositions within the network shown in FIG. 9A. The transmission link 923 between the light sources 920 and the signal tap 908 is preferably optical fiber, but may be some other form of light transmission means as described above. Also, the monitor/controller 906 in FIG. 9B has a similar disposition to and has all the functions of the monitor/controller of the network in FIG. 9A. However, the monitor/controller 906 in FIG. 9B has the additional function of sending control signals to the light sources 920 via an additional communications line 922.

FIG. 9C illustrates a third preferred embodiment of a network which utilizes a VOA in accordance with the present invention. The network illustrated in FIG. 9C is similar to the network shown in FIG. 9B except that the power output of an optical amplifier 924, instead of a set of transmitter light sources 920, is monitored and controlled by the monitor/controller 906 and VOA 910. Attenuated signals are input to optical amplifier 924 after having passed through a span 926 of optical fiber. All remaining elements of the network of FIG. 9C have similar disposition and functioning to those of the network of FIG. 9B.

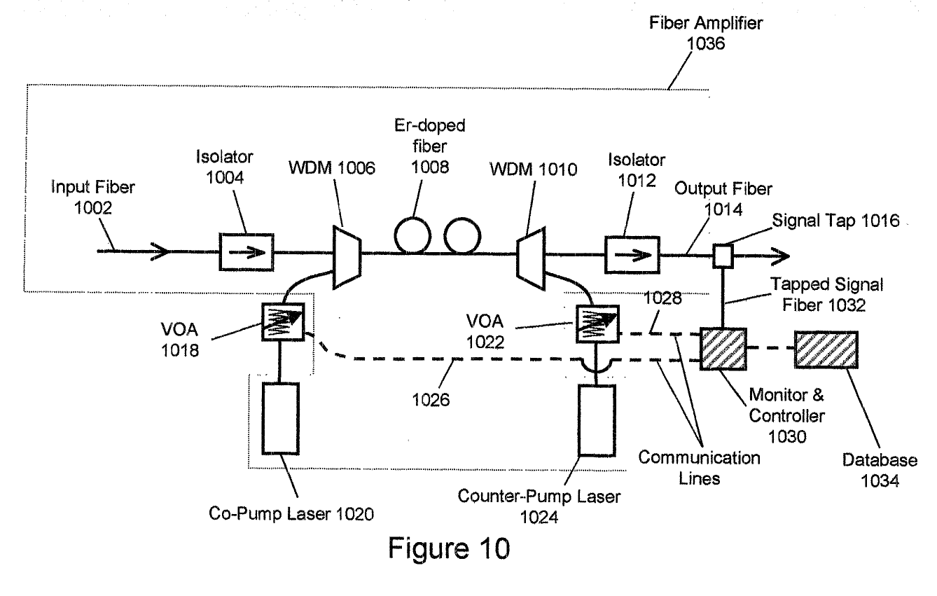

FIG. 10 illustrates a fourth preferred embodiment of a network which utilizes a VOA in accordance with the present invention. The network in FIG. 10 uses a plurality of VOA's 1018, 1022 to moderate the output of pump lasers 1020, 1024 comprising the amplifier by which the output power of a fiber amplifier 1036 may be controlled. The pump lasers 1020, 1024 emit light at wavelengths that are shorter than those of any signals being amplified. The network illustrated in FIG. 10 may, for instance, comprise the means by which the optical amplifier 924 is controlled in the network of FIG. 9C. In FIG. 10, the input fiber 1002, output fiber 1014, input isolator 1004, output isolator 1012, input WDM 1006, output WDM 1010, co-pump laser 1020, counter-pump laser 1024 and Er-doped fiber 1008 are common components of fiber amplifiers of the prior art. However, in the network of FIG. 10, a signal tap 1016, monitor/controller unit 1030, database unit 1034, communications lines 1026-1028 and first 1018 and/or second 1022 VOA supplement the other components. The signal tap 1016 diverts a very small proportion of the output of the fiber amplifier 1036 to the monitor/controller 1030 via an additional optical fiber 1032. The monitor/controller 1030 comprises an optical detector (not specifically illustrated) which detects the optical power level of the signal sample diverted to it from the signal tap 1016. The monitor/controller 1030 then performs a calculation that logically converts this information into the optical power output of the fiber amplifier 1036, wherein the optical power is launched into the output fiber 1014. Based on the results of this calculation, the monitor/controller 1030 sends, via the communications lines 1026-1028, control signals to the first 1018 and second 1022 VOA, disposed along the optical pathway of the co-pump laser 1020 and counter-pump laser 1024, respectively. By this means, the pump power levels launched into the Er-doped fiber 1008 are controlled and thus the optical gain of the amplifier 1036 is controlled. The database 1034, which is preferably a computer or other electronic recording device, receives information from the monitor/controller 1030 and maintains it in a permanent record of the amplifier output and VOA control signals. The information stored in the database 1034 may be used to monitor the performance of the fiber amplifier 1036 and detect degradation or failures of the various components comprising the amplifier.

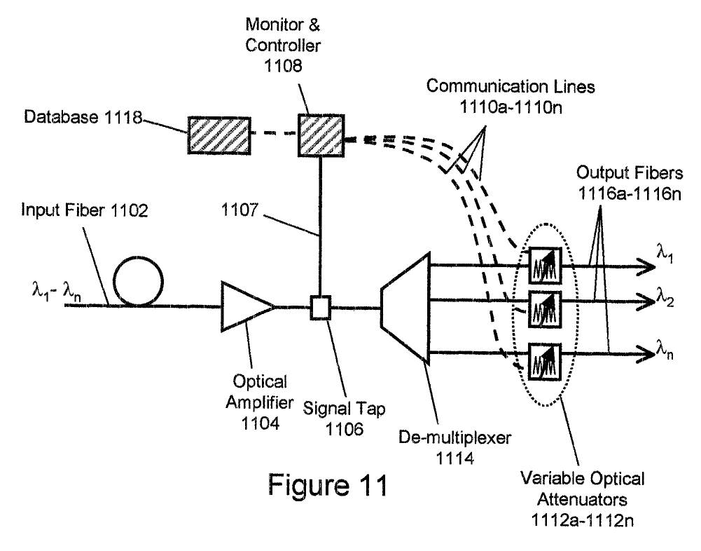

FIG. 11 illustrates a fifth preferred embodiment of a network which utilizes a VOA in accordance with the present invention. The network in FIG. 11 uses a plurality of VOA's by which to equalize the optical power levels of n separate signals channels or wavelengths λ₁-λₙ after they are output of an optical amplifier within a wavelength division multiplexed optical communications system. In the network of FIG. 11, attenuated signals are input to optical amplifier 1104 after having passed through a span 1102 of optical fiber. After the optical amplifier 1104 amplifies the signals, small proportions of each of the resulting amplified output signals are diverted to a monitor/controller 1108 by a signal tap 1106 and an auxiliary fiber 1107. The monitor/controller 1108 then performs calculations that logically convert this information into the optical power output of each signal channel output by the optical amplifier 1104. Based on the results of this calculation, the monitor/controller 1108 sends, via the n communications lines 1110a-1110n, n separate and independent control signals to a set of VOA's 1112a-1112n. The remainder of the optical amplifier output (i.e., that proportion not diverted by signal tap 1106 to monitor/controller 1108) is de-multiplexed into its individual signal channels by the wavelength de-multiplexer 1114. After this de-multiplexing step, each signal channel or wavelength propagates along its own unique optical pathway. Disposed along each of these signal optical pathways is a single respective VOA that is used to moderate the optical power level of the signal propagating along said respective pathway. Each VOA 1112a-1112n attenuates the optical power level of the signal channel passing through it without any effect upon any of the other channels.

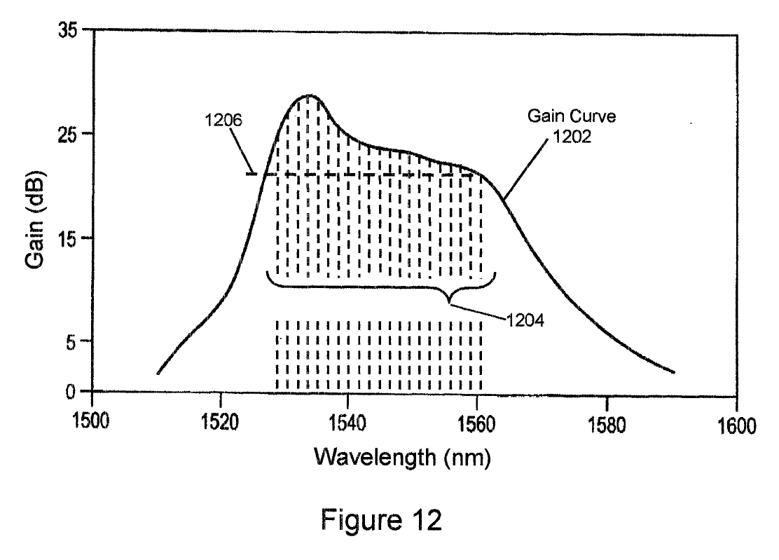

The monitor/controller 1108 sends a plurality of control signals, one control signal to each VOA 1112a-1112n, based upon the calculated optical power of each channel output from the amplifier. A record of the monitored power levels and VOA control signals is stored in a database 1118, which is preferably a computer or other electronic data storage means. In this fashion, the output power of each channel may be controlled independently of all the other channels. Relatively more intense channels receive a proportionally greater degree of attenuation such that, subsequent to power moderation by the set of VOA's 1112a-1112n, the relative channel intensity levels are as shown by the horizontal dashed line 1206 of FIG. 12. After passing through the set of VOA's 1112a-1112n, the individual channel signals may be multiplexed together once again so as to be propagated along a single output fiber system (not shown).

FIG. 12 illustrates amplifier gain flattening accomplished via the network of FIG. 11. The gain curve 1202 in FIG. 12 represents a typical gain profile for an Er-doped fiber amplifier. The set 1204 of vertical dashed lines in FIG. 12 represent the locations of channels spaced at 200 GHz according to a standardized grid scheme recommended by the International Telecommunication Union (ITU). Generally, without optical power equalization, the relative power levels of signals output from the amplifier will follow the amplifier gain profile as shown by the full length of the vertical dashed lines trending up to the curve 1202. However, by providing variable independent attenuation to each channel via the network of FIG. 11, the gain and output of all channels may be equalized to a common level as illustrated by the horizontal dashed line 1206 of FIG. 12.

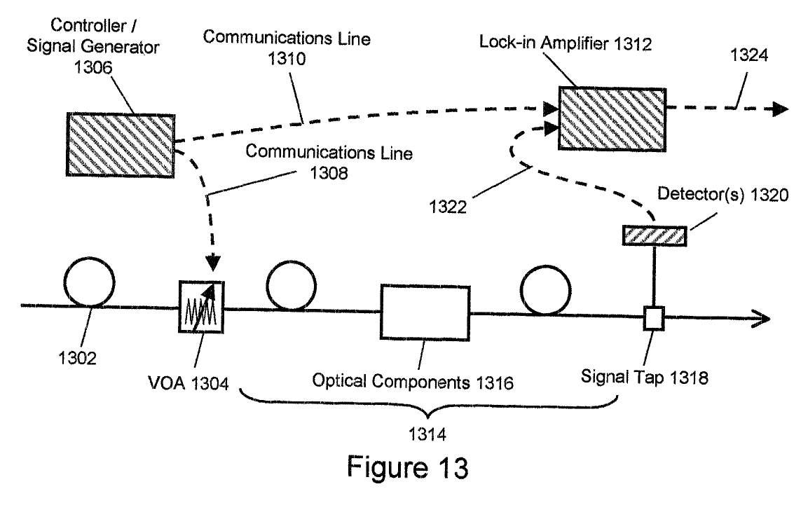

Finally, FIG. 13 illustrates a sixth preferred embodiment of a network which utilizes a VOA in accordance with the present invention. The network of FIG. 13 uses a VOA to chop an optical beam carried over an optical fiber system so as, when used in conjunction with a lock-in amplifier, to provide optical output detection with improved signal-to-noise characteristics. In FIG. 13, an input optical fiber 1302 provides a light or plurality of lights to a VOA 1304, which imposes a regular intensity modulation of the light or lights. A controller/signal generator 1306 controls the modulation of the VOA 1304 by providing a regularly timed control signal to the VOA 1304 via communications line 1308. The controller/signal generator 1306 also provides, via communications line 1310, a reference signal to the lock-in amplifier 1312. The signals transmitted along the communications lines 1308 and 1310 are synchronized to one another. The modulated light output from the VOA 1304 caused by the modulation of the VOA 1304 is caused to propagate through a span 1314 of a network partially comprised of a set 1316 of one or more optical components.

Each of the optical components of the set 1316 causes insertion loss. Because of the combined insertion losses of all optical components within the network, there may be appreciable attenuation of the light during propagation over the length of the fiber span 1314. At the end of the span, a signal tap 1318 diverts a proportion of the light to one or more photo-detectors 1320. Because of the attenuation of the light during propagation through the fiber optic system, the light received by the detector(s) 1320 may be of very low intensity and, as a result, the raw output of the detector(s) may be associated with an unacceptably low signal-to-noise ratio. To improve the signal-to-noise characteristics, the raw output from the detector(s) is input to a lock-in amplifier 1312 together with the reference signal provided by the controller/signal generator 1306. Lock-in amplifiers, which are well known in the art, amplify only the frequency component of the input at the reference signal and filter out all other frequencies. Background noise will, in general cause a range of frequency responses in the detector output. However, only the light beam, as modulated by the VOA 1304 will be associated with the frequency of the reference signal transmitted over communications line 1310, because this is also the modulation frequency of the VOA 1304. By this means, the detector output is amplified with high signal-to-noise and very weak attenuated light beams may be reliably detected. The electrical output 1324 from the lock-in amplifier 1312 is proportional to the optical power level detected by detector 1320. The output 1324 may lead to a computer, gauge, meter, or some other power-monitoring or recording database or circuitry (not shown).

A network may comprise any combination of uses of the VOA as described above with FIGS. 9A through 13 without departing from the spirit and scope of the present invention.

A method and system for variable gain attenuation has been disclosed. The method and system utilizes a variable optical attenuator comprising a movable micro-mechanical support with a mirror coating. An optical signal is transferred onto the mirror coating, which is then reflected back. The movable support may be tilted at a desired angle such that the optical signal is reflected back into an output optical fiber with a controlled variable misalignment. The variable optical attenuator in accordance with the present invention is capable of precise and reproducible operation. It is capable of attenuating the optical signal in real time and in attenuating all of the channels in an optical signal simultaneously. Because of its small size, it is extremely rigid and vibration insensitive. Because it has no bulk mechanical parts, it does not wear out. Furthermore, by coupling the variable optical attenuator to a multiple-port circulator, attenuation is achieved in a bi-directional optical fiber system.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for attenuating power in an optical signal in an optical network, comprising the steps of:
(a) providing the optical signal to a reflective surface;
(b) tilting the reflective surface at a desired angle, wherein the reflective surface comprises a mirror coating on a movable support; and
(c) reflecting the optical signal into an optical fiber, wherein the reflected optical signal enters the optical fiber with a misalignment based upon the angle.

2. The method of claim 1, wherein the movable support comprises a cantilever arm.

3. The method of claim 1, wherein the movable support comprises:
a rotating plate; and
a plurality of torsion beams coupled to the rotating plate.

4. The method of claim 1, wherein the reflective surface comprises a spherical surface.

5. The method of claim 1, wherein the reflective surface comprises an off-axis parabolic surface.

6. A variable optical attenuator, comprising:
a movable support;
a reflective surface on the movable support capable of reflecting an optical signal; and
a tilting means coupled to the reflective surface for tilting the reflective surface at a desired angle.

7. The attenuator of claim 6, wherein the movable support comprises a cantilever arm.

8. The attenuator of claim 6, wherein the movable support comprises:
a rotating plate; and
a plurality of torsion beams coupled to the rotating plate.

9. The attenuator of claim 6, wherein the reflective surface comprises a spherical surface.

10. The attenuator of claim 6, wherein the reflective surface comprises an off-axis parabolic surface.

11. A system, comprising:
a signal tap for receiving an optical signal, wherein the signal tap diverts a proportion of the optical signal in one direction and diverts a remaining proportion of optical signal in another direction;
a controller for receiving the proportion, wherein the controller determines an optical power level of the optical signal based upon an analysis of the proportion, wherein the controller outputs a control signal based upon the determined optical power level; and
at least one variable optical attenuator for receiving the remaining proportion and the control signal, wherein the at least one variable optical attenuator attenuates the remaining proportion based upon the control signal, wherein the at least one variable optical attenuator comprises:
a movable support,
a reflective surface on the movable support capable of reflecting the remaining proportion, and
a tilting means coupled to the reflective surface for tilting the reflective surface at a desired angle.

12. The system of claim 11, wherein the movable support comprises a cantilever arm.

13. The system of claim 11, wherein the movable support comprises:
a rotating plate; and
a plurality of torsion beams coupled to the rotating plate.

14. The system of claim 11, wherein the reflective surface comprises a spherical surface.

15. The system of claim 11, wherein the reflective surface comprises an off-axis parabolic surface.

16. The system of claim 11, further comprising:
at least one optical passive component optically coupled to the signal tap for providing the optical signal.

17. The system of claim 11, further comprising:
a plurality of light sources optically coupled to the signal tap for providing the optical signal.

18. The system of claim 11 further comprising:
an optical amplifier optically coupled to the signal tap for providing the optical signal.

19. The system of claim 18, further comprising:
a de-multiplexer optically coupled between the signal tap and the at least one variable optical attenuator, wherein the de-multiplexer de-multiplexes the remaining proportion of the optical signal into a plurality of signal channels, wherein the at least one variable optical attenuator attenuates each of the plurality of signal channels based upon the control signal.

20. The system of claim 11, further comprising:
a database coupled to the controller for recording data comprising the determined optical power level.

21. The system of claim 11, further comprising:
a fiber amplifier coupled to the at least one variable optical attenuator for providing an optical signal.

22. The system of claim 21, wherein the fiber amplifier comprises:
an input fiber;
a first isolator optically coupled to the input fiber;
a first wavelength division multiplexer (WDM) optically coupled to the first isolator;
an erbium-doped fiber optically coupled to the first WDM;
a second WDM optically coupled to the erbium-doped fiber;
a second isolator optically coupled to the second WDM;
an output fiber;
a co-pump laser optically coupled to the first WDM; and
a counter-pump laser optically coupled to the second WDM.

23. A system, comprising:
a controller for providing a control signal and a reference signal;
a variable optical attenuator for receiving the control signal and for providing a regular intensity modulation of an optical signal based upon the control signal, wherein the variable optical attenuator comprises:
a movable support,
a reflective surface on the movable support capable of reflecting the optical signal, and a
tilting means coupled to the reflective surface for tilting the reflective surface at a desired angle;
a plurality of optical components optically coupled to the variable optical attenuator through which the modulated optical signal is propagated;
a signal tap optically coupled to the plurality of optical components, wherein the signal tap directs a proportion of the propagated optical signal in one direction and directs a remaining proportion of the propagated optical signal in another direction;
a photodetector for receiving the proportion; and
a lock-in amplifier for receiving the reference signal and the detected proportion and for amplifying the detected proportion based upon the reference signal.

24. The system of claim 23, wherein the movable support comprises a cantilever arm.

25. The system of claim 23, wherein the movable support comprises:
a rotating plate; and
a plurality of torsion beams coupled to the rotating plate.

26. The system of claim 23, wherein the reflective surface comprises a spherical surf ace.

27. The system of claim 23, wherein the reflective surface comprises an off-axis parabolic surface.
